(19) United States
(12) Patent Application Publication
(10) Pub. No.: US 2024/0303348 A1
(43) Pub. Date: Sep. 12, 2024

(54) KNOWLEDGE AND WISDOM EXTRACTION AND CODIFICATION FOR MACHINE LEARNING APPLICATIONS

(71) Applicant: Salem Cyber, Winston Salem, NC (US)

(72) Inventor: Jonathan William Bagg, Winston Salem, NC (US)

(21) Appl. No.: 18/599,759

(22) Filed: Mar. 8, 2024

Related U.S. Application Data
(60) Provisional application No. 63/489,245, filed on Mar. 9, 2023.

(51) Int. Cl. G06F 21/57; G06F 40/20

(52) U.S. Cl. CPC G06F 21/577; G06F 40/20

(57) ABSTRACT

A device accesses a set of computer security alerts and generates a first training dataset comprising first training examples. Each first training example includes a computer security alert labeled with characteristics associated with a predetermined cause. The device trains an NLP model using the first training dataset for identifying a set of characteristics of a cause of the computer security alert. The device generates a second training dataset by generating variants of one or more of the accessed set of computer security alerts. Each generated variant computer security alert is associated with a variant set of characteristics of a variant cause of the variant computer security alert, and each second training example includes a generated variant computer security alert labeled as an above-threshold threat or a below-threshold threat. The device trains a neural network model to generate a measurement of threat of the computer security alert.

### CROSS-REFERENCE TO RELATED APPLICATIONS

This application claims a benefit of U.S. Provisional Application No. 63/489,245, filed Mar. 9, 2023, which is incorporated by reference herein in its entirety.

### TECHNICAL FIELD

The disclosure generally relates to the field of computer security, and more particularly relates to detecting computer security threats using machine learning models.

### BACKGROUND

Computer security alerts that are used for detecting and mitigating potential threats may suffer from several deficiencies that may impact their effectiveness and reliability. One common deficiency in computer security alerts is the occurrence of false positives, where benign or normal activities are erroneously flagged as potential security threats. False positives can result from misconfigurations, outdated threat intelligence, or imperfect algorithms, leading to wasted resources, alert fatigue, and diminished trust in the security system. For example, security personnel waste time and resources to investigate and respond to alerts that ultimately turn out to be non-threatening. This diversion of resources can strain cybersecurity teams and hinder their ability to address genuine security incidents effectively. Frequent false positives may desensitize security personnel and lead to alert fatigue. When security professionals are inundated with a high volume of false alarms, they may become less inclined to investigate alerts thoroughly, potentially overlooking genuine security threats in the process. Inaccurate computer security alerts represent a significant challenge in cybersecurity, emphasizing the importance of fine-tuning security systems to reduce false alarms while maintaining the ability to effectively detect and respond to genuine threats.

### SUMMARY

Systems and methods are disclosed herein for automating the measurement of a threat for a computer security alert. In an embodiment, the method includes accessing a set of computer security alerts and generating a first training dataset using the set of computer security alerts. The first training dataset may include a plurality of first training examples, each of which includes a computer security alert labeled with one or more characteristics associated with a predetermined cause. The method further includes training an NLP model using the first training dataset for identifying a set of characteristics of a cause of the computer security alert. The method may include generating a second training dataset by generating variants of one or more of the accessed sets of computer security alerts. Each generated variant computer security alert is associated with a variant set of characteristics of a variant cause of the variant computer security alert. The second training dataset includes a plurality of second training examples, and each second training example includes a generated variant computer security alert labeled as an above-threshold threat or a below-threshold threat. The method includes training a neural network model using the second training dataset. The neural network is configured to, when applied to the set of identified characteristics of the identified cause of the computer security alert output by the NLP model, generate a measurement of threat of the computer security alert.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

Figure (FIG. 1 illustrates one embodiment of a system environment including a computing device with a security module, according to one or more embodiments.

FIG. 2 illustrates one embodiment of exemplary sub-modules of a security module, according to one or more embodiments.

FIG. 3 illustrates a flow diagram for determining a measurement of threat of a computer security alert, according to one or more embodiments.

FIG. 4 is a flowchart illustrating a process for training a natural language processing (NLP) model and a neural network model for determining a measurement of threat of a computer security alert, according to one or more embodiments.

FIG. 5 is a block diagram illustrating components of an example machine able to read instructions from a machine-readable medium and execute them in a processor (or controller), according to one or more embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

One embodiment of a disclosed system, method and computer readable storage medium includes a security module that enables a computing device to determine a measurement of threat of a computer security alert. In some embodiments, the disclosure herein includes training two models in tandem. The two models may include various algorithms and model, such as, machine learning models, statistic models, rule-based models, large language models, deep learning models, etc. In some embodiments, the two model may include: an NLP (Natural Language Processing) model and a neural network model. The NLP model first parses the computer security alert's content to identify a set of characteristics that are indicative of the cause underlying the creation of the alert. The NLP model's feature extraction capabilities allow for an understanding of the contextual and semantic meaning within the alert's content. This addition of context-awareness can reduce the likelihood of misinterpreting benign events as threats. The neural network model uses the identified characteristics output by the NLP model to deduce a quantitative threat measurement. By setting a suitable threat level threshold, the method may categorize computer security alerts as above-threshold and below-threshold (e.g., potential false positives), thereby suppressing computer security alerts that do not meet certain threat criteria. Because both models have been trained on a dataset of genuine threats and benign events, they together provide greater discriminative power to distinguish between true and false alerts.

### System Overview

Figure (FIG. 1 illustrates one embodiment of a system environment 100, according to one or more embodiments. The system environment 100 includes a computing device 110 with a security module 140, a network 120, and a client device 130. The system environment 100 may also include different or additional entities.

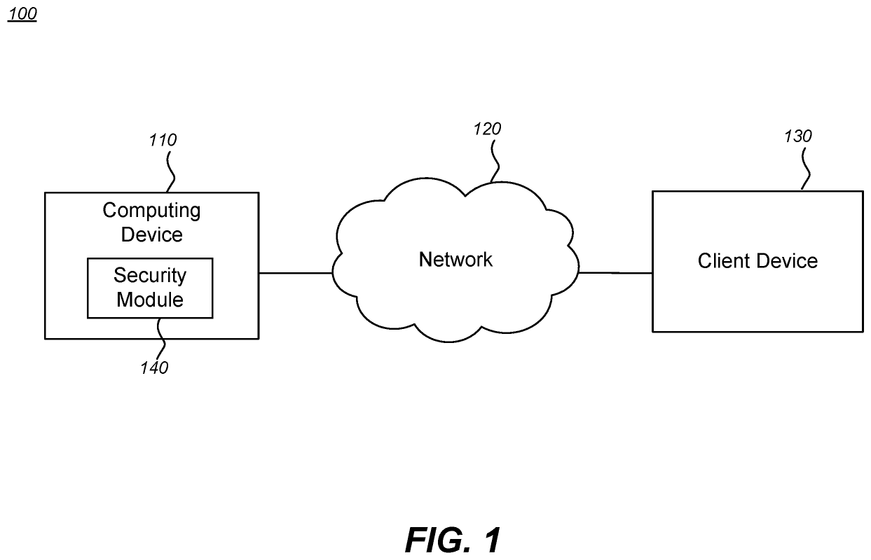

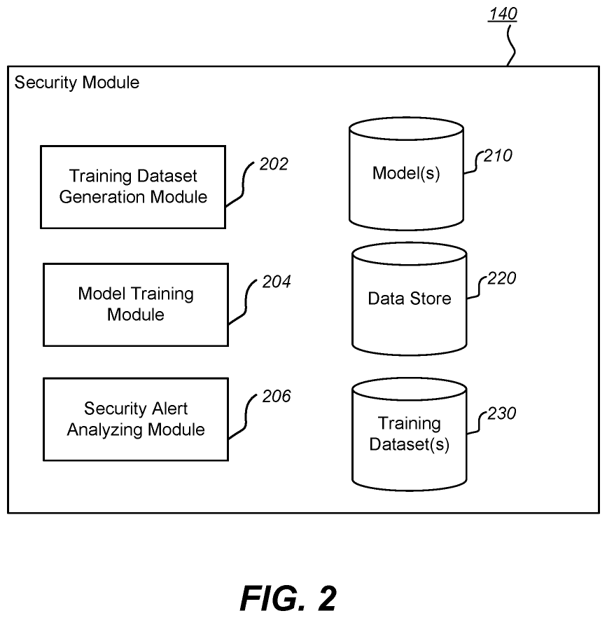

The computing device 110 accesses computer security alerts and determines a measurement of threat for the computer security alerts. The computing device 110 may include a singular computing system, such as a single computer, or a network of computing systems, such as a data center or a distributed computing system. The computing device 110 may be one or more servers (e.g., forming a cloud-based service) that receives data and performs analysis to determine a measurement of threat. In some implementations, the computing device 110 may receive the computer security alerts from one or more client devices 130 via the network 120. The computing device 110 may determine the measurement of threat for each received computer security alert and transmit the determined measurement to the corresponding client device 130. In some implementations, the security module 140 in the computing device 110 performs the task of determining the measurement of threat by applying a natural language processing (NLP) model and a neural network model to the received computer security alert. In some embodiments, the measurement of threat may include a level of threat, a security action recommendation, and a request for additional information, etc. The security module 140 may transmit a notification to the client device 130 to take actions based on the determined measurement of threat. Further details about security module 140 are described below with reference to FIGS. 2-4.

The network 120 includes any combination of local area and/or wide area networks, using wired and/or wireless communication systems. The network 120 may use standard communications technologies and/or protocols. For example, the network 120 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network may be represented using any suitable format, such as hypertext markup language (HTML) or extensible markup language (XML). In some embodiments, all or some of the communication links of the network 120 may be encrypted using any suitable technique or techniques.

A client device 130 is a computing device that belongs to a client of the computing device 110. The client device 130 may be any computing device. Example of such client device 130 may include a personal computer, a desktop, a laptop, a smart phone, a tablet, a wearable computing device such as a smart watch, an Internet-of-Things (IoT) device, and the like. The client device 130 may communicate with the computing device 110 via the network 120. In some embodiments, the client device 130 may include security applications that detect security risks of the client device 130 and transmit the detected computer security alert to the computing device 110 for determining a measurement of threat. In some implementations, the computing device 110 may detect security risks in the client device 130, generate a computer security alert, determine a measurement of threat, and transmit the computer security alert and the measurement of threat to the client device 130.

### Security Module Configuration

FIG. 2 illustrates one embodiment of exemplary sub-modules of a security module 140, according to one or more embodiments. The security module 140 includes a training dataset generation module 202, a model training model 204, a security alert analyzing module 206, one or more models 210, a data store 220, and one or more training datasets 230. The modules depicted with respect to security module 140 are exemplary; more or fewer modules, and data may be used, consistent with the disclosure provided herein.

The training dataset generation module 202 generates training datasets 230 for training the one or more models 210. In one example, the training dataset generation module 202 may generate a first training dataset that is used for training an NLP model. The first training dataset may include a plurality of first training examples. In some embodiments, the training examples may be obtained by using historic security alerts. Each first training example may include a computer security alert labeled with one or more characteristics associated with a predetermined cause of the computer security alert. The characteristics may be real and actuate descriptors of the underlying activity of the computer security alert. In some embodiments, one or more characteristics may be used collectively to indicate a known state of a computer security alert. A computer security alert may include one or more groupings of characteristics. The groupings may include, for example, “action,” “source account,” user account,” “data type,” etc., and each grouping may include a set of values. For example, the grouping of “action” may include values, such as, “authentication,” “remove,” “password,” “print,” etc.; and the grouping of “user account” may include, e.g., “regular user,” “shared account,” “password expired,” and the like. In some embodiments, the combinations of the groupings and the values of the corresponding groupings may be associated with the characteristics of a predetermined cause of a computer security alert, and/or used to identify a predetermined cause for the computer security alert.

In some embodiments, the first training dataset may include first training examples that are related to false positive computer security alert. For example, a computer security alert may include text content, e.g., “Source IP: 192.168.1.100,” “Destination IP: 1.2.3.4,” “Protocol: TCP,” and the like. This computer security alert may suggest that there is suspicious outbound network traffic originating from a specific source IP address (192.168.1.100) to a well-known public IP address (1.2.3.4) on port 443, which is commonly associated with HTTPS traffic. However, further investigation might reveal that the traffic is actually legitimate, such as a software update or legitimate communication with a trusted service (1.2.3.4). Therefore, this computer security alert turns out to be a false positive and the training dataset generation module 202 may label this computer security alert accordingly.

In some embodiments, the security module 140 may receive additional information and/or feedback from a human operator via a user interface. For example, the feedback may indicate a computer security alert is a false positive alert. The feedback may further identify one or more characteristics of the computer security alert that are indicative of the false positive alert, e.g., the IP address (1.2.3.4) is safe. The training dataset generation module 202 may store the identified one or more characteristics and update the labels of the first training examples.

In some embodiments, the data store 220 may access a mapping that maps contextual information and one or more terms included in a computer security alert. For example, the terms included in a computer security alert may include a common security alert name, IP address, detected behaviors, etc. This context-term mapping may capture dependencies and relationships between the alert content and its underlying context, enabling accurate extraction of characteristics. In some embodiments, the training dataset generation module 202 may generate the mapping using historic computer security alerts. In some embodiments, the training dataset generation module 202 may update the mapping based on updated information of computer security alerts, such as the evolution of the computer security risks, the release of new software and firmware updates, and the occurrence of cybersecurity events, etc. Based on the mapping, the training dataset generation module 202 may label each first training example with one or more characteristics associated with a predetermined cause of the computer security alert included in the first training example.

In another example, the training dataset generation module 202 may generate a second training dataset that is used for training a neural network model. The second training dataset may include a plurality of second training examples. The training dataset generation module 202 may generate the second training dataset by generating variants of accessed set of computer security alerts. In one example, each generated variant computer security alert is associated with a variant set of characteristics of a variant cause of a variant computer security alert. A “variant set of characteristics” may refer to characteristics that have been altered or mutated to reflect a different cause, e.g., the “variant cause” of the variant computer security alert. In the example of the false positive computer security alert discussed above, the variant set of characteristics may include, e.g., “Source IP: 192.168.1.111,” “Source IP: 192.168.2.100,” “Destination IP: 6.6.6.6,” “Destination IP: 7.7.7.7,” etc. Each second training example may include a generated variant computer security alert that is labeled as an above-threshold threat or a below-threshold threat. In some implementations, the training dataset generation module 202 may determine the threshold level of a computer security alert based on the risk level, organization policies, specific context of the alerts, etc. For example, characteristics associated with a false positive computer security alert may be labeled as a below-threshold threat.

In some embodiments, the training dataset generation module 202 may obtain contextual information related to characteristics of a computer security alert. In one example, a user identifies that the account “jan.bragg” has a role of admin, and the training dataset generation module 202 may incorporate this information in the training dataset for analyzing future computer security alerts. For example, when a future computer security alert involves the account jan.bragg, the security alert analyzing module 206 may identify that this account is categorized as admin. In another example, a user identifies how they know the account jan.bragg may be classified as an admin, such as querying a directory technology for role associations. The training dataset generation module 202 may incorporate this information in the training dataset so that when detecting a computer security alert which has an account “dan.hagg”, the security alert analyzing module 206 determine if this account can be classified as an admin.

The model training model 204 trains the one or more models 210 using the one or more training datasets 230. In one implementation, the model training model 204 may use the first training dataset to train an NLP model and use the second training dataset to train a neural network model. In one example, the model training model 204 may apply the NLP model to the plurality of first training examples. The NLP model may include large language model, recurrent neural networks (RNNs), convolutional neural networks (CNNs), transformers, and their variants. In some implementations, the NLP model may include retraining, updating, finetuning, customizing, and/or contextualizing of a foundational language model. For instance, the model training model 204 inputs the first training examples into the NLP model which learns to map input text included in the computer security alert in each first training example to the corresponding labels or predictions. The model training model 204 may train the NLP model to recognize patterns, sequences, and structures within the text that point towards specific characteristics, thus improving its ability to pinpoint cause-related markers within computer security alerts. The trained NLP model is configured to, when applied to a computer security alert, identify a set of characteristics of a cause of the computer security alert.

In one implementation, the model training model 204 may use the second training dataset to train a neural network model. In one example, the model training model 204 may apply the neural network model to the plurality of second training examples so that the neural network model learns to discern patterns and relationships between the characteristics, the causes, and the corresponding threat levels. The neural network model may include Feedforward Neural Network (FNN), Convolutional Neural Network (CNN), Recurrent Neural Network (RNN), Long Short-Term Memory (LSTM) Network, etc. In some embodiments, the neural network model may be one of foundational language models, and the model training model 204 may the language model to obtain a customized trained neural network model. In one example, the neural network may use a loss function that measures the difference between the model's predicted level of thread and the actual target level of threat. The model training model 204 may iteratively train the neural network model by input the second training examples to the model to obtain predictions, compute the loss using the loss function, backpropagates the model by updating the parameters of the model based on the computed, and repeat the training process until a stopping criterion is met (e.g., a maximum number of epochs, convergence). The model training model 204 may use various techniques to compute the loss, for example, using multi-head attention, masked language modeling, etc. The neural network model is configured to, when applied to the set of identified characteristics of the identified cause of the computer security alert outputted by the NLP model, determine a level of threat for the computer security alert. In some embodiments, the neural network model may generate an output indicating whether the computer security alert is an above-threshold threat or a below-threshold threat. In some embodiments, the neural network model may generate a measurement of threat of the computer security alert. The measurement of threat of the computer security alert may include a level of threat, a security action recommendation, a request for additional information, etc.

The security alert analyzing module 206 determines a measurement of threat of a computer security alert. Upon receiving a computer security alert at the security module 140, the security alert analyzing module 206 applies one or more models 210 to determine the measurement of threat for the computer security alert. In one implementation, the security alert analyzing module 206 may apply the NLP model the received computer security alert and output a set of characteristics of a cause of the computer security alert. In some embodiments, the security alert analyzing module 206 may apply the neural network model to the set of characteristics and receives an output that includes a level of threat of the computer security alert, e.g., above-threshold or below-threshold. Based on the level of threat, the security module 140 may generate a measurement of threat. For example, in response to determining that the computer security alert is an above-threshold threat, the security module 140 may modify an interface that is displayed to a human operator for presenting the level of threat, the measurement of threat, etc. In some embodiments, the security alert analyzing module 206 may determine various states of the computer security alert. For example, the security alert analyzing module 206 may determine the computer security alert in a state that needs more information and the model does not have enough “confidence” to push the alert above the threshold; or a state that does not have not enough data/context type and the model does not fully process an alert because no enough data is in the alert to properly run, so no “score” (e.g., a level of threat) is ever given.

In some embodiments, the security alert analyzing module 206 may make a prediction/determination of what is the next piece of context to gather, and that prioritization is used in asking questions in specific workflows. The security module 140 may receive additional information and/or feedback from a human operator via the interface. The additional input may provide supplementary validation or contextual insights, further enhancing the accuracy and reliability of the threat assessment process. The security alert analyzing module 206 may incorporate additional input to validate or refute the computer security alert's validity.

The models 210 may include a plurality of models, for example, the NLP model, the neutral network models and the like. In some embodiments, the models 210 may include machine learning model, rule-based models, statistic models, deep learning models, etc.

The data store 220 may include a non-transitory computer-readable storage medium that stores information used to train the models and/or to determine the measurement of threat for a computer security alert, such as, historic computer security alerts, system information, context information, security procedures, etc. The training datasets 230 includes the training datasets for training the one or more models 210. For example, the training datasets 230 may include the first training dataset for training the NLP model and the second training dataset for training the neural network model. In some implementations, the training datasets 230 may be stored in the data store 220. In some embodiments, the data store 220 may be integrated as a part of the computing device 110. Alternatively, the data store 220 may be located differently from the computing device 110.

### Process of Determining Measurement of Threat

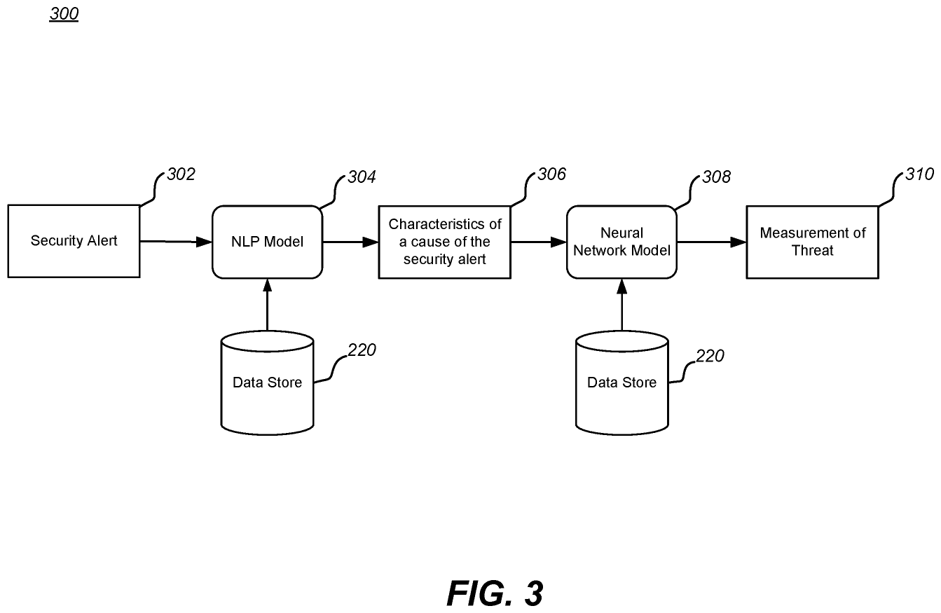

FIG. 3 illustrates a flow diagram for determining a measurement of threat of a computer security alert, according to one or more embodiments. In various embodiments, the process includes different or additional steps than those described in conjunction with FIG. 3. Further, in some embodiments, the steps of the process may be performed in different orders than the order described in conjunction with FIG. 3. The process described in conjunction with FIG. 3 may be carried out by the computing device 110 (e.g., security module 140) in various embodiments.

As shown in FIG. 3, the security module 140 may access a computer security alert 302. For example, the security module 140 may receive the computer security alert 302 from a client device 130. In another example, the security module 140 may have direct access to the security system in the client device 130 and generate the computer security alert 302 for the client device 130. The security module 140 may apply the NLP model 304 to the computer security alert 302 to identify a set of characteristics of a cause of the computer security alert 306. In some embodiments, when applying the NLP model 304, the security module 140 may access the data store 220 to retrieve historic security alert information and/or context information for generating the set of characteristics 306. The security module 140 may apply the neural network model 308 to the identified set of characteristics to generate a measurement of threat of the computer security alert 310. In some embodiments, when applying the neural network model 308, the security module 140 may access the data store 220 to retrieve historic security alert information and/or context information for generating the measurement of threat 310.

In some implementations, the security module 140 may receive additional information and/or feedback from a user. For example, the security module 140 may receive feedback from a user (e.g., human operator) indicating that the computer security alert is a false positive alert, and/or receive information identifying that one or more of the identified set of characteristics are indicative of the false positive alert. The security module 140 may store the one or more characteristics of the computer security alert for indicating the false positive alert.

In some embodiments, when the security module 140 accesses a subsequent computer security alert and applies the NLP model to the subsequent computer security alert, the security module 140 may identify a set of characteristics of a cause of the subsequent computer security alert has some characteristics in common with the stored characteristics of the false positive alert. The security module 140 may modify the set of characteristics of the subsequent computer security alert based on the identified characteristics of the computer security alert that are indicative of the false positive alert. The security module 140 applies the neural network model to the modified set of characteristics to produce a measurement of threat of the subsequent computer security alert. In some embodiments, the measurement of threat of the computer security alert includes one or more of a level of threat, a security action recommendation, and a request for additional information. In some embodiments, the security module 140 may take specific actions based on the determined measurement of threat and the user's requirement. These actions may include the updating/closing of a support ticket, a remediation action, etc.

### Process of Training NLP Model and Neural Network Model

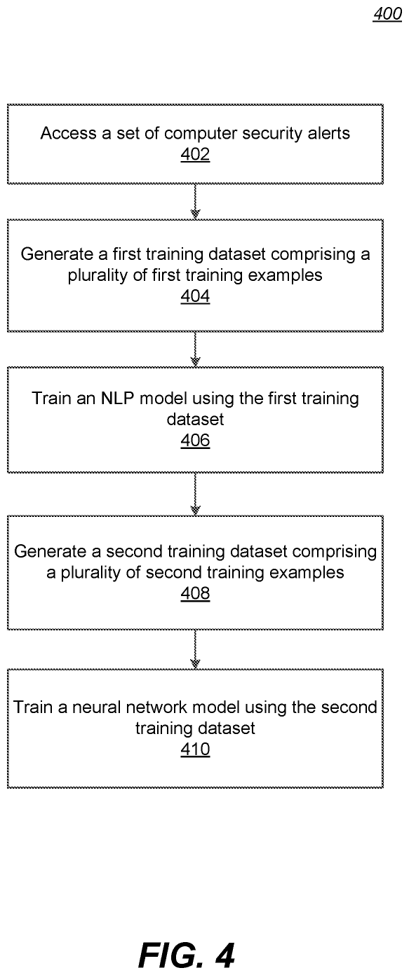

FIG. 4 is a flowchart illustrating a process for training a natural language processing (NLP) model and a neural network model for determining a measurement of threat of a computer security alert, according to one or more embodiments. In various embodiments, the process includes different or additional steps than those described in conjunction with FIG. 4. Further, in some embodiments, the steps of the process may be performed in different orders than the order described in conjunction with FIG. 4. The process described in conjunction with FIG. 4 may be carried out by the computing device 110 (e.g., security module 140) in various embodiments.

As shown in FIG. 4, the computing device 110 may access 402 a set of computer security alerts and generate 404 a first training dataset using the set of security alerts. The first training dataset may include a plurality of first training examples, and each first training example includes a computer security alert labeled with one or more characteristics associated with a predetermined cause of the computer security alert. The computing device 110 may train 406 a natural language processing (NLP) model using the first training dataset. In some embodiments, the NLP model is configured to, when applied to a computer security alert, identify a set of characteristics of a cause of the computer security alert. The computing device 110 may generate 408 a second training dataset which includes a plurality of second training examples. The computing device 110 may generate the second training dataset by generating variants of one or more of the accessed set of computer security alerts. Each generated variant computer security alert is associated with a variant set of characteristics of a variant cause of the variant computer security alert, and each second training example includes a generated variant computer security alert labeled as an above-threshold threat or a below-threshold threat. The computing device 110 may train 410 a neural network model using the second training dataset. The neural network model is configured to, when applied to the set of identified characteristics of the identified cause of the computer security alert outputted by the NLP model, generate a measurement of threat of the computer security alert. In some embodiments, the measurement of threat of the computer security alert includes one or more of a level of threat, a security action recommendation, and a request for additional information.

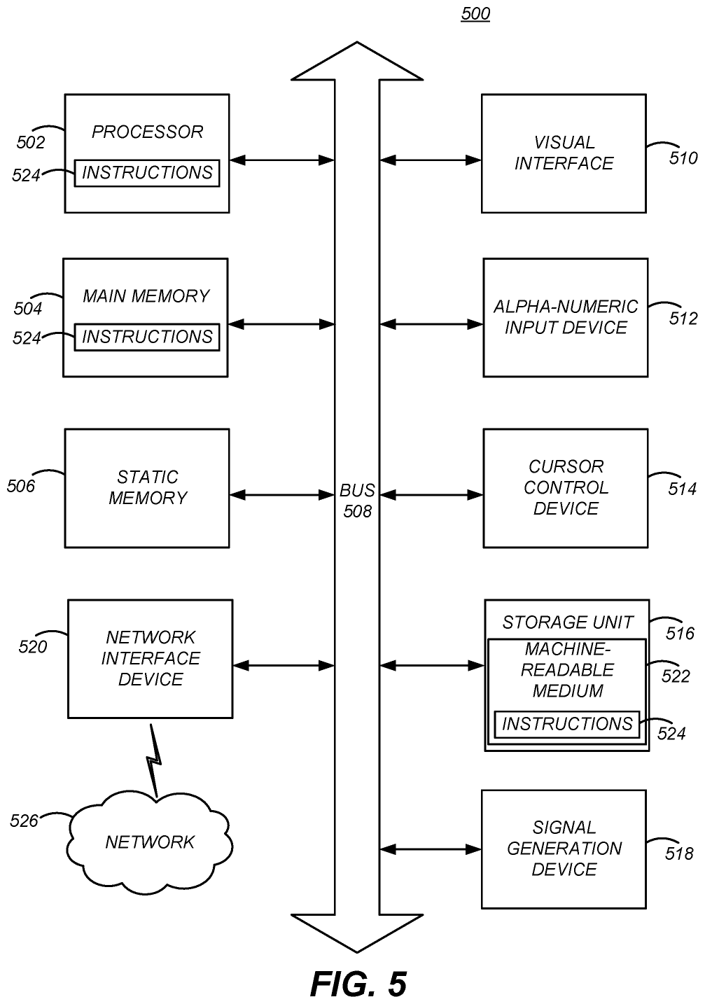

FIG. 5 is a block diagram illustrating components of an example machine able to read instructions from a machine-readable medium and execute them in a processor (or controller). Specifically, FIG. 5 shows a diagrammatic representation of a machine in the example form of a computer system 500 within which program code (e.g., software) for causing the machine to perform any one or more of the methodologies discussed herein may be executed. The program code may be comprised of instructions 524 executable by one or more processors 502. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a tablet, a web appliance, a network router, switch or bridge, or any machine capable of executing instructions 524 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 500 includes a processor 502 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 504, and a static memory 506, which are configured to communicate with each other via a bus 508. The computer system 500 may further include visual display interface 510. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 510 may include or may interface with a touch enabled screen. The computer system 500 may also include alphanumeric input device 512 (e.g., a keyboard or touch screen keyboard), a cursor control device 514 (e.g., a mouse, a trackball, a joystick, a motion sensor, or other pointing instrument), a storage unit 516, a signal generation device 518 (e.g., a speaker), and a network interface device 520, which also are configured to communicate via the bus 508.

The storage unit 516 includes a machine-readable medium 522 on which is stored instructions 524 (e.g., software) embodying any one or more of the methodologies or functions described herein. The instructions 524 (e.g., software) may also reside, completely or at least partially, within the main memory 504 or within the processor 502 (e.g., within a processor's cache memory) during execution thereof by the computer system 500, the main memory 504 and the processor 502 also constituting machine-readable media. The instructions 524 (e.g., software) may be transmitted or received over a network 526 via the network interface device 520.

While machine-readable medium 522 is shown in an example embodiment to be a single medium, the term “machine-readable medium” should be taken to include a single medium or multiple media (e.g., a centralized or distributed database, or associated caches and servers) able to store instructions (e.g., instructions 524). The term “machine-readable medium” shall also be taken to include any medium that is capable of storing instructions (e.g., instructions 524) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method comprising:
accessing a set of computer security alerts;
generating a first training dataset comprising a plurality of first training examples using the set of computer security alerts, each first training example comprising a computer security alert labeled with one or more characteristics associated with a predetermined cause of the computer security alert;
training a natural language processing (NLP) model using the first training dataset, the NLP model configured to, when applied to a computer security alert, identify a set of characteristics of a cause of the computer security alert;
generating a second training dataset comprising a plurality of second training examples by generating variants of one or more of the accessed set of computer security alerts, each generated variant computer security alert associated with a variant set of characteristics of a variant cause of the variant computer security alert, and each second training example comprising a generated variant computer security alert labeled as an above-threshold threat or a below-threshold threat; and
training a neural network model using the second training dataset, the neural network model configured to, when applied to the set of identified characteristics of the identified cause of the computer security alert outputted by the NLP model, generate a measurement of threat of the computer security alert.

2. The method of claim 1, further comprising:
accessing a first target computer security alert;
applying the NLP model to the first target computer security alert to identify a first set of target characteristics of a first target cause of the first target computer security alert;
applying the neural network model to the identified first set of target characteristics to generate a first target measurement of threat of the first target computer security alert; and
in response to determining that the first target computer security alert is associated with the above-threshold threat, modifying an interface displayed to a human operator to present first target measurement of threat.

3. The method of claim 2, further comprising:
receiving, via the interface, feedback from the human operator indicating that the first target computer security alert is a false positive alert;
receiving, via the interface, information from the human operator identifying one or more characteristics of the first target computer security alert that are indicative of the false positive alert; and
storing the identified one or more characteristics of the first target computer security alert for indicating the false positive alert.

4. The method of claim 3, further comprising:
accessing a second target computer security alert;
applying the NLP model to the second target computer security alert to identify a second set of target characteristics of a second target cause of the second target computer security alert;
in response to determining that the second set of target characteristics and the first set of target characteristics have one or more characteristics in common, modifying the second set of target characteristics based on the identified one or more characteristics of the first target computer security alert that are indicative of the false positive alert; and
applying the neural network model to the modified second target set of characteristics to produce a second target measurement of threat of the second target computer security alert.

5. The method of claim 1, wherein the NLP model is trained on information of common security alert names and historic computer security alerts.

6. The method of claim 1, wherein generating a first training dataset comprising a plurality of first training examples comprises:
accessing a mapping between contextual information and one or more terms included in the computer security alert in each first training example; and
labeling each first training example using the contextual information based on the accessed mapping.

7. The method of claim 1, wherein the measurement of threat of the computer security alert includes one or more of a level of threat, a security action recommendation, and a request for additional information.

8. A non-transitory computer readable medium configured to store instructions, the instructions when executed by one or more processors causing the one or more processors to perform operations comprising:
accessing a set of computer security alerts;
generating a first training dataset comprising a plurality of first training examples using the set of computer security alerts, each first training example comprising a computer security alert labeled with one or more characteristics associated with a predetermined cause of the computer security alert;
training a natural language processing (NLP) model using the first training dataset, the NLP model configured to, when applied to a computer security alert, identify a set of characteristics of a cause of the computer security alert;
generating a second training dataset comprising a plurality of second training examples by generating variants of one or more of the accessed set of computer security alerts, each generated variant computer security alert associated with a variant set of characteristics of a variant cause of the variant computer security alert, and each second training example comprising a generated variant computer security alert labeled as an above-threshold threat or a below-threshold threat; and
training a neural network model using the second training dataset, the neural network model configured to, when applied to the set of identified characteristics of the identified cause of the computer security alert outputted by the NLP model, generate a measurement of threat of the computer security alert.

9. The non-transitory computer readable medium of claim 8, wherein the instructions when executed by one or more processors cause the one or more processors to further perform operations comprising:
accessing a first target computer security alert;
applying the NLP model to the first target computer security alert to identify a first set of target characteristics of a first target cause of the first target computer security alert;
applying the neural network model to the identified first set of target characteristics to generate a first target measurement of threat of the first target computer security alert; and
in response to determining that the first target computer security alert is associated with the above-threshold threat, modifying an interface displayed to a human operator to present first target measurement of threat.

10. The non-transitory computer readable medium of claim 9, wherein the instructions when executed by one or more processors cause the one or more processors to further perform operations comprising:
receiving, via the interface, feedback from the human operator indicating that the first target computer security alert is a false positive alert;
receiving, via the interface, information from the human operator identifying one or more characteristics of the first target computer security alert that are indicative of the false positive alert; and
storing the identified one or more characteristics of the first target computer security alert for indicating the false positive alert.

11. The non-transitory computer readable medium of claim 10, wherein the instructions when executed by one or more processors cause the one or more processors to further perform operations comprising:
accessing a second target computer security alert;
applying the NLP model to the second target computer security alert to identify a second set of target characteristics of a second target cause of the second target computer security alert;
in response to determining that the second set of target characteristics and the first set of target characteristics have one or more characteristics in common, modifying the second set of target characteristics based on the identified one or more characteristics of the first target computer security alert that are indicative of the false positive alert; and
applying the neural network model to the modified second target set of characteristics to produce a second target measurement of threat of the second target computer security alert.

12. The non-transitory computer readable medium of claim 8, wherein the NLP model is trained on information of common security alert names and historic computer security alerts.

13. The non-transitory computer readable medium of claim 8, wherein the instructions to generate a first training dataset comprising a plurality of first training examples when executed by one or more processors cause the one or more processors to further perform operations comprising:
accessing a mapping between contextual information and one or more terms included in the computer security alert in each first training example; and
labeling each first training example using the contextual information based on the accessed mapping.

14. The non-transitory computer readable medium of claim 8, wherein the measurement of threat of the computer security alert includes one or more of a level of threat, a security action recommendation, and a request for additional information.

15. A system comprising memory with instructions encoded thereon that, when executed by one or more processors, cause the one or more processors to perform operations comprising:
accessing a set of computer security alerts;
generating a first training dataset comprising a plurality of first training examples using the set of computer security alerts, each first training example comprising a computer security alert labeled with one or more characteristics associated with a predetermined cause of the computer security alert;
training a natural language processing (NLP) model using the first training dataset, the NLP model configured to, when applied to a computer security alert, identify a set of characteristics of a cause of the computer security alert;
generating a second training dataset comprising a plurality of second training examples by generating variants of one or more of the accessed set of computer security alerts, each generated variant computer security alert associated with a variant set of characteristics of a variant cause of the variant computer security alert, and each second training example comprising a generated variant computer security alert labeled as an above-threshold threat or a below-threshold threat; and
training a neural network model using the second training dataset, the neural network model configured to, when applied to the set of identified characteristics of the identified cause of the computer security alert outputted by the NLP model, generate a measurement of threat of the computer security alert.

16. The system of claim 15, wherein the instructions when executed by one or more processors cause the one or more processors to further perform operations comprising:
accessing a first target computer security alert;
applying the NLP model to the first target computer security alert to identify a first set of target characteristics of a first target cause of the first target computer security alert;
applying the neural network model to the identified first set of target characteristics to generate a first target measurement of threat of the first target computer security alert; and
in response to determining that the first target computer security alert is associated with the above-threshold threat, modifying an interface displayed to a human operator to present first target measurement of threat.

17. The system of claim 16, wherein the instructions when executed by one or more processors cause the one or more processors to further perform operations comprising:
receiving, via the interface, feedback from the human operator indicating that the first target computer security alert is a false positive alert;
receiving, via the interface, information from the human operator identifying one or more characteristics of the first target computer security alert that are indicative of the false positive alert; and
storing the identified one or more characteristics of the first target computer security alert for indicating the false positive alert.

18. The system of claim 17, wherein the instructions when executed by one or more processors cause the one or more processors to further perform operations comprising:
accessing a second target computer security alert;
applying the NLP model to the second target computer security alert to identify a second set of target characteristics of a second target cause of the second target computer security alert;
in response to determining that the second set of target characteristics and the first set of target characteristics have one or more characteristics in common, modifying the second set of target characteristics based on the identified one or more characteristics of the first target computer security alert that are indicative of the false positive alert; and
applying the neural network model to the modified second target set of characteristics to produce a second target measurement of threat of the second target computer security alert.

19. The system of claim 15, wherein the NLP model is trained on information of common security alert names and historic computer security alerts.

20. The system of claim 15, wherein the instructions to generate a first training dataset comprising a plurality of first training examples when executed by one or more processors cause the one or more processors to further perform operations comprising:
accessing a mapping between contextual information and one or more terms included in the computer security alert in each first training example; and
labeling each first training example using the contextual information based on the accessed mapping.
